(19) United States
(12) Patent Application Publication
(10) Pub. No.: US 2011/0134945 A1
(43) Pub. Date: Jun. 9, 2011

(54) LENGTHENING THE PATH OF A PUMP BEAM IN A MONOLOTHIC SOLID STATE LASER APPARATUS

(75) Inventors: Yaniv VIDNE, Petah-Tikva (IL); Nissim ZAFRANI, Bnei Brak (IL); Shmuel GREENSTEIN, Rehovot (IL); Dov ABRAMOVICH, Tel-Aviv (IL); Yoav LAVON, Nes Ziona (IL)

(73) Assignee: ELBIT SYSTEMS ELECTRO-OPTICS ELOP LTD., Rehovot (IL)

(21) Appl. No.: 12/975,565

(22) Filed: Dec. 22, 2010

Related U.S. Application Data
(63) Continuation-in-part of application No. 11/817,578, filed on Aug. 31, 2007.

(30) Foreign Application Priority Data
Mar. 1, 2005 (IL) 167174

(51) Int. Cl. H01S 3/10; H01S 3/06

(52) U.S. Cl. 372/25; 372/66

(57) ABSTRACT

A solid state laser device with a lengthened pump beam path is provided herein. The laser device includes an active element having a specified geometric shape, specified optical characteristics, and further configured for lasing; and a light pumping element optically coupled to the active element, wherein the light pumping element is configured to generate a pump light beam directed at a specified angle into the active element, and wherein at least one of: the specified angle, the specified geometric shape, and the specified optical characteristics are selected such that the pump light beam is reflected one or more times within the active element resulting in an extension of an absorption path of the pump light beam within the active element.

### CROSS REFERENCE TO RELATED APPLICATIONS

This application is a Continuation-in-Part of U.S. patent application Ser. No. 11/817,578 which is a national stage of International Patent Application No. PCT/IL2006/000258 which claimed priority to foreign Israeli Patent Application No. 167,174 filed on Mar. 1, 2005, all of which are incorporated by reference.

### BACKGROUND

1. Technical Field

The present invention relates generally to laser devices, and more particularly, to solid state laser devices.

2. Discussion of the Related Art

Laser pumping is the act of energy transfer from an external source into the gain medium of a laser. The energy is absorbed in the medium, producing excited states in its atoms. When the number of particles in one excited state exceeds the number of particles in the ground state or a less-excited state, population inversion is achieved. In this condition, the mechanism of stimulated emission can take place and the medium can act as a laser or an optical amplifier. The pump power must be higher than the lasing threshold of the laser.

### BRIEF SUMMARY

One aspect of the invention provides a monolithic solid state laser apparatus having a longer pump beam path than similar solid states laser devices of similar size and shape. The lengthening of the pump beam path is achieved by locating a light pumping element along the side and near the edge of an active element and at a specified angle towards the active element. In addition to selecting the location and the angle to optimize the coupling between the pumping element and the active element, to yield maximal lasing for a given pumping, the location and the angle are further selected so that at least one reflection of the pump light beam within the active element is achieved. The one or more reflections may be achieved in various ways and contributes, among other things, to the robustness of the laser apparatus in terms of temperature related operational range.

Another aspect of the invention provides a solid state laser device that includes an active element configured as a gain medium for lasing; two or more light pumping elements optically coupled to the active element, wherein each light pumping element is associated with a specified absorption range; and a control module in operative association with the light pumping elements, wherein the control unit is configured to: deduce the momentary operational wavelength of each light pumping element at any given time; de-activate a light pumping element whenever its operational wavelength goes beyond a specified range on its respective absorption range; and re-activate a de-activated light pumping element whenever its operational wavelength goes within the specified range on its respective absorption range. By this feature, a higher operational range in terms of temperature is further achieved.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1 is a schematic diagram illustrating a laser device according to some embodiments of the present invention;

FIG. 2 is a schematic diagram illustrating a laser device according to some embodiments of the present invention;

FIG. 3 is a schematic diagram illustrating a laser device according to some embodiments of the present invention;

FIG. 4 is a schematic diagram illustrating a laser device according to some embodiments of the present invention;

FIG. 5 is a schematic diagram illustrating a laser device according to some embodiments of the present invention;

FIG. 6 is a schematic diagram illustrating a laser device according to some embodiments of the present invention;

FIG. 7 is a graph diagram illustrating absorption lines of different light pumping elements according to some embodiments of the present invention;

FIG. 8 is a flowchart diagram illustrating a method of laser pumping according to some embodiments of the present invention;

The drawings together with the following detailed description make apparent to those skilled in the art how the invention may be embodied in practice.

### DETAILED DESCRIPTION

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

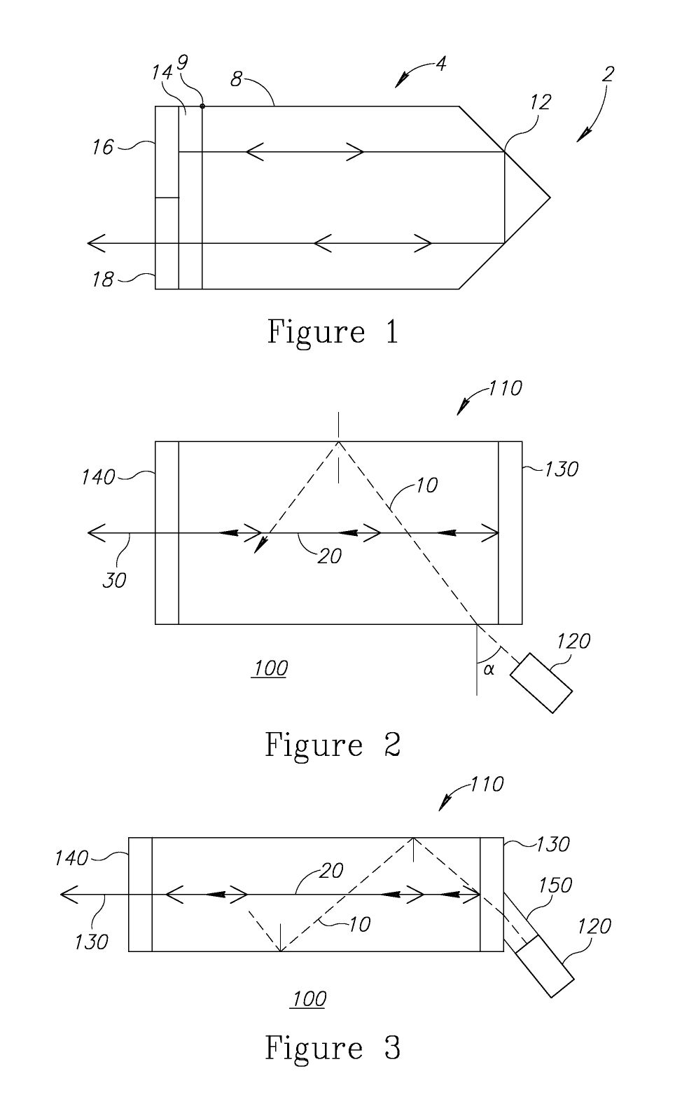

FIG. 1 is a schematic diagram illustrating a laser device according to some embodiments of the present invention. Solid-state laser apparatus 2, including a solid-state active element 4 having major surfaces and first and second edges 10 and 12 oppositely disposed to each other, the first edge 9 being flat and the second edge 12 being constituted by first and second perpendicularly disposed surfaces 12 or having first and second perpendicularly disposed surfaces 12 located adjacent to the second edge, a back reflector 16 and an output coupler 18 located at, or adjacent to, the first edge 10 light induced in the cavity forms two parallel beams passing therethrough, by means of a first beam which is reflected by the back reflector 16 towards a first of the perpendicularly disposed surfaces and being folded to pass on to the second surface, to be further folded and to proceed towards the first edge 10. A saturable absorber 14 may be attached to the first edge 9.

FIG. 2 is a schematic diagram illustrating a laser device 100 according to some embodiments of the present invention. Laser device 100 may include an active element having a specified geometric shape, specified optical characteristics, and further configured for lasing; and a light pumping element 120 optically coupled via a lens, for example, to the active element, wherein light pumping element 120 is configured to generate a pump light beam 10 directed at a specified angle a into the active element. For the sake of simplicity, the refraction of pump light beam 10 upon entering active element 110 is not shown.

Upon entering active element 110, pump light beam 10 is being diffused or reflected or absorbed along an absorption path within the gain medium. Consistent with embodiments of the invention, the absorption path is extended by configuring and selecting the specified angle α and either the specified geometric shape or the specified optical characteristics (or a combination thereof) such that pump light beam 10 is reflected or diffused one or more times within the active element. Extension of the absorption path of pump light beam 10 within active element 110 increases the efficiency of active element 110 as a gain medium which improves its tolerance to temperature variance.

Laser beam 20 that has been generated by the lasing of active element 110 as affected by the extended absorption path of light pump beam 10 may then be reflected by reflector 130 and coupled out of active element 110 by output coupler 140.

Consistent with one embodiment of the invention, the reflections of pump light beam 10 within active element 110 are total internal reflections (TIR). This is achieved by selecting the specified angle and least one of the specified geometric shape and the specified optical characteristics such that TIR conditions are met where pump light beam hit the inner surfaces of active element 110. Alternatively, the reflection may be achieved by a diffusive reflection or by a mirror layer located either within active element 100 or outside active element 100 as will be explained below.

As shown, light pumping element 120 is located along the side and near the edge of active element 110. In addition to selecting the location for optimization of the coupling to yield maximal lasing for a given pumping the location has been selected so that at least one reflection of pump light beam 10 is achieved. FIG. 3 shows a slightly different configuration in which light pumping element 120 is located on one edge of active element 110 coupled through an optical coupler 150 and directed at a specified angle resulting in reflection of pump light beam 10 within active element 110 until it is fully absorbed. Consistent with one embodiment of the invention the active element is elongated and is associated with a longitudinal axis so that the specified angle is defined by the longitudinal axis and the pump light beam as generated by the light pumping element.

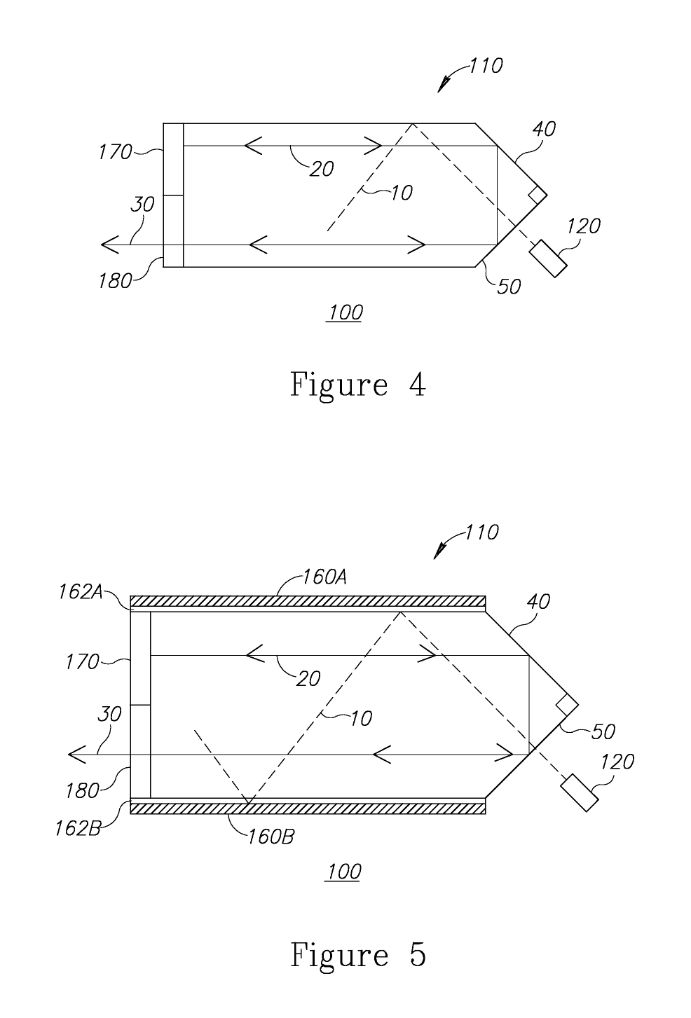

FIG. 4 is a schematic diagram illustrating a laser device according to some embodiments of the present invention. The laser apparatus includes an active element 110, in addition to the aforementioned features explained with references to FIGS. 2 and 3, further includes a double slopes 40 and 50 portion defining a right angle or any angle between the slopes 40 and 50 wherein the pump light beam is directed perpendicularly or in other angle into one of the slopes (e.g. 50). In addition, an output coupler, implemented as a reflector 170 and element 180 such as a Q-switch or a combination of both is configured to output a laser beam 30 from the active element and is located on a portion of the active element, opposite of the double slope portion, the double slope portion is configured such that the laser beam travels at least twice along the long axis of the active element. It is understood to a person skilled in the art that the aforementioned configuration may be implemented in an amplifier configuration, namely without element 180 and similar couplers.

FIG. 5 is a schematic diagram illustrating a laser device according to some embodiments of the present invention. Consistent with one embodiment, least one surface of the active element is coated with a reflective layer 106A+B such as diffusive pigment or ceramic and the like configured to reflect pump light beam 10. This feature is required whenever TIR conditions cannot be met or are undesirable. For example, in some applications there is a need for unpolished surfaces of active element 110 and so TIR conditions cannot be established. According to the ceramic reflective layer feature, the reflection occurs outside active element 110, such as within glue layer 162. In addition, the ceramic reflective layer may be further configured to dissipate heat caused by absorption of the pump light beam 10 within the active element, thus serving as an additional heat sink.

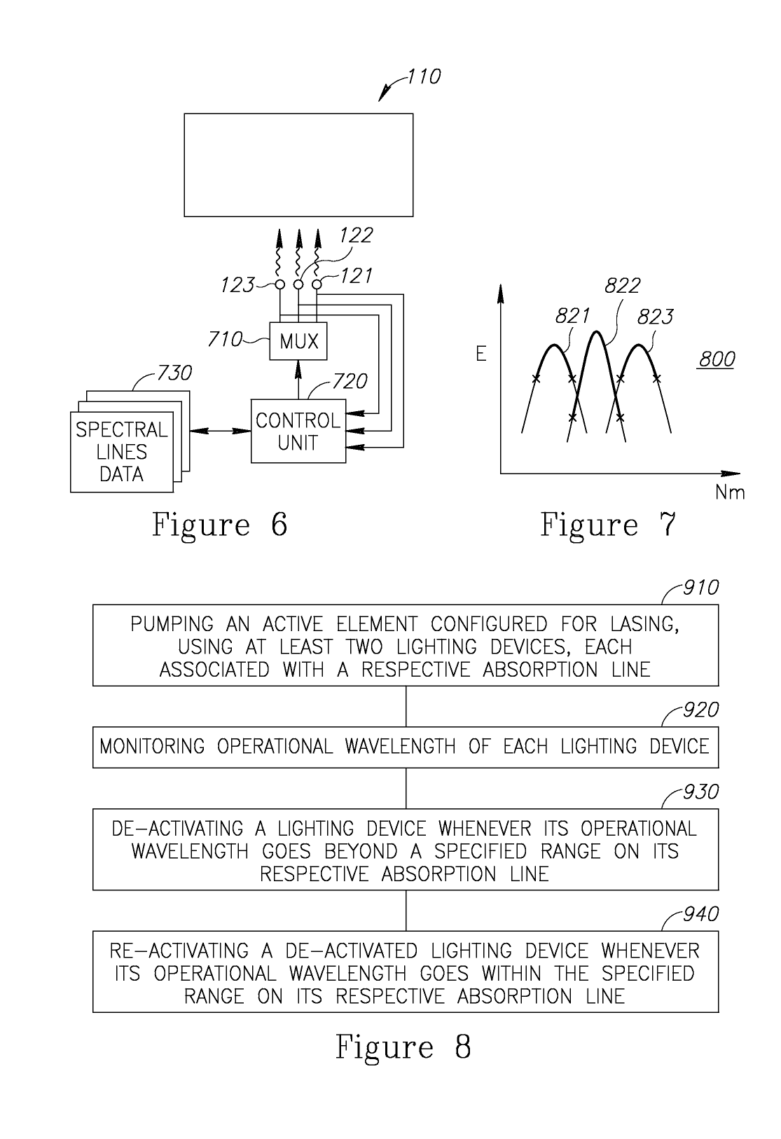

FIG. 6 is a schematic diagram illustrating a laser device according to some embodiments of the present invention. Solid state laser device may include: an active element 110 configured as a gain medium for lasing; two or more light pumping elements 121-123 optically coupled to active element 110. A control unit 720 is in operative association with light pumping elements 121-123 via multiplexer 710 and is further in operative associating with a temperature dependence lookup table 730. FIG. 7 is a graph diagram illustrating emission lines of light pumping elements 121-123. As shown, emission lines 821-823 have each a specified range of efficiency (marked in bold lines bordered by x).

In operation, each one of light pumping elements 121-123 is associated with a specified absorption range as shown and a control module in operative association with the light pumping elements, wherein the control unit is configured to: monitor operational wavelength of each light pumping element; de-activate a light pumping element whenever its operational wavelength goes beyond a specified range on its respective absorption line; and re-activate a de-activated light pumping element whenever its operational wavelength goes within the specified range on its respective absorption line.

Consistent with one embodiment of the invention multiplexer 710 being in operative association with control unit 720 is configured to de-activate and re-activate the light pumping element responsive of control unit 720. In addition, control unit 720 is further configured to compare actual operational wavelength of each light pumping element to spectral lines data 730 for determining efficiency range of the light pumping elements upon which the deactivating and re-activating is based.

Advantageously, multiplexing operation of the pump lighting elements overcomes the need to stabilize the operation of the pump lighting elements (usually diodes) which have a tendency to have a varying operation wavelength dependent upon temperature. The aforementioned feature thus improves the temperature independence (and hence the temperature operational range) of a solid state laser device. Consistent with yet another embodiment of the invention active element 110 may include the aforementioned feature of the lengthened path of the pump beam with the aforementioned feature of the pump light multiplexing. The combination further improves the robustness of the laser apparatus in terms of operational range.

FIG. 8 is a flowchart diagram illustrating a method of laser pumping according to some embodiments of the present invention. The method may include the following steps: pumping an active element configured for lasing, using two or more light pumping elements, each associated with a respective absorption line 910. The method goes on to deducing a momentary operational wavelength of each light pumping element 920. Then, the method goes on to de-activating a light pumping element whenever its operational wavelength goes beyond a specified range on its respective absorption line 930 and finally to re-activating a de-activated light pumping element whenever its operational wavelength goes within the specified range on its respective absorption line. Naturally, the deactivating and re-activating may be repeated on an ad hoc basis based on the operational wavelength of each pump lighting element.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A solid state laser device comprising:
an active element having a specified geometric shape, specified optical characteristics, and further configured as a gain medium for lasing; and
one or more light pumping elements optically coupled to the active element,
wherein the light pumping element is configured to generate a pump light beam directed at a specified angle into the active element, and
wherein at least one of: the specified angle, the specified geometric shape, and the specified optical characteristics are selected such that the pump light beam is reflected one or more times within the active element resulting in an extension of an absorption path of the pump light beam within the active element.

2. The laser device according to claim 1, wherein the at least one of: the specified angle, the specified geometric shape, and the specified optical characteristics are further selected such that the one or more reflections are total internal reflections.

3. The laser device according to claim 1, wherein at least one surface of the active element is coated with a reflective layer configured to reflect the pump light beam.

4. The laser device according to claim 3, wherein the ceramic reflective layer is coupled to the active element with transparent glue.

5. The laser device according to claim 3, wherein the ceramic reflective layer is further configured to dissipate heat caused by the lasing within the active element.

6. The laser device according to claim 1, wherein the active element comprises a double slope portion defining a right angle between the slopes, wherein the pump light beam is directed into one of the slopes, and wherein an output coupler configured to output a laser beam from the active element is located on a portion of the active element, opposite of the double slope portion, the double slope portion is configured such that the laser beam travels at least twice along the long axis of the active element.

7. The laser device according to claim 1, wherein the one or more light pump elements include at least two pump light elements, wherein each one of the light pump elements is associated with a distinct absorption line, and
wherein the laser device further comprises a control module in operative association with the light pumping elements, and further configured to:
deduce momentary operational wavelength of each light pumping element;
de-activate a light pumping element whenever its operational wavelength goes beyond a specified range on its respective absorption line; and
re-activate a de-activated light pumping element whenever its operational wavelength goes within the specified range on its respective absorption line.

8. The laser device according to claim 7, further comprising a multiplexer in operative association with the control unit and the light pumping elements, and wherein the control unit is configured to de-activate and re-activate the light pumping element via the a multiplexer.

9. The laser device according to claim 7, wherein the control unit is further configured to compare actual operational wavelength of each light pumping element to spectral lines data for determining efficiency range of the light pumping elements upon which the deactivating and re-activating is based.

10. A method of generating a laser beam comprising:
providing an active element configured for lasing;
coupling into the active element a light pump beam at an angle selected such that the light pump beam is reflected one or more times within the active element to yield an increased absorption path; and
coupling out from the active element, a laser beam affected by the increased absorption path.

11. The method according to claim 10, wherein each light pumping element is associated with a specified absorption line, and wherein the method further comprising:
deducing operational wavelength for each light pumping element;
de-activating a light pumping element whenever its operational wavelength goes beyond a specified range on its respective absorption line; and
re-activating a de-activated light pumping element whenever its operational wavelength goes within the specified range on its respective absorption line.

12. A solid state laser device comprising:
an active element configured as a gain medium for lasing;
two or more light pumping elements optically coupled to the active element, wherein each light pumping element is associated with a specified absorption line; and
a control module in operative association with the light pumping elements,
wherein the control unit is configured to:
monitor operational wavelength of each light pumping element;
de-activate a light pumping element whenever its operational wavelength goes beyond a specified range on its respective absorption line; and
re-activate a de-activated light pumping element whenever its operational wavelength goes within the specified range on its respective absorption line.

13. The laser device according to claim 12, further comprising a multiplexer in operative association with the control unit and the light pumping elements, and wherein the control unit is configured to de-activate and re-activate the light pumping element via the multiplexer.

14. The laser device according to claim 12, wherein the control unit is further configured to compare actual operational wavelength of each light pumping element to spectral lines data for determining an efficiency range of the light pumping elements upon which the deactivating and re-activating is based.

15. A method comprising:
pumping an active element configured for lasing, using two or more light pumping elements, each associated with a respective absorption line;
deducing operational wavelength for each light pumping element;
de-activating a light pumping element whenever its operational wavelength goes beyond a specified range on its respective absorption line; and
re-activating a de-activated light pumping element whenever its operational wavelength goes within the specified range on its respective absorption line.
